(19) United States
(12) Patent Application Publication
(10) Pub. No.: US 2015/0025881 A1
(43) Pub. Date: Jan. 22, 2015

(54) SPEECH SIGNAL SEPARATION AND SYNTHESIS BASED ON AUDITORY SCENE ANALYSIS AND SPEECH MODELING

(71) Applicant: Audience, Inc., Mountain View, CA (US)

(72) Inventors: Avendano Carlos, Campbell, CA (US); David Klein, Los Altos, CA (US); John Woodruff, Menlo Park, CA (US); Michael M. Goodwin, Scotts Valley, CA (US)

(21) Appl. No.: 14/335,850

(22) Filed: Jul. 18, 2014

Related U.S. Application Data
(60) Provisional application No. 61/856,577, filed on Jul. 19, 2013.
(60) Provisional application No. 61/972,112, filed on Mar. 28, 2014.

(51) Int. Cl. G10L 15/20

(52) U.S. Cl. CPC G10L 15/20
USPC 704/233

(57) ABSTRACT

Provided are systems and methods for generating clean speech from a speech signal representing a mixture of a noise and speech. The clean speech may be generated from synthetic speech parameters. The synthetic speech parameters are derived based on the speech signal components and a model of speech using auditory and speech production principles. The modeling may utilize a source-filter structure of the speech signal. One or more spectral analyses on the speech signal are performed to generate spectral representations. The feature data is derived based on a spectral representation. The features corresponding to the target speech according to a model of speech are grouped and separated from the feature data. The synthetic speech parameters, including spectral envelope, pitch data and voice classification data are generated based on features corresponding to the target speech.

### CROSS-REFERENCE TO RELATED APPLICATIONS

The present application claims the benefit of U.S. Provisional Application No. 61/856,577, filed on Jul. 19, 2013 and entitled “System and Method for Speech Signal Separation and Synthesis Based on Auditory Scene Analysis and Speech Modeling”, and U.S. Provisional Application No. 61/972,112, filed Mar. 28, 2014 and entitled “Tracking Multiple Attributes of Simultaneous Objects”. The subject matter of the aforementioned applications is incorporated herein by reference for all purposes.

### TECHNICAL FIELD

The present disclosure relates generally to audio processing, and, more particularly, to generating clean speech from a mixture of noise and speech.

### BACKGROUND

Current noise suppression techniques, such as Wiener filtering, attempt to improve the global signal-to-noise ratio (SNR) and attenuate low-SNR regions, thus introducing distortion into the speech signal. It is common practice to perform such filtering as a magnitude modification in a transform domain. Typically, the corrupted signal is used to reconstruct the signal with the modified magnitude. This approach may miss signal components dominated by noise, thereby resulting in undesirable and unnatural spectro-temporal modulations.

When the target signal is dominated by noise, a system that synthesizes a clean speech signal instead of enhancing the corrupted audio via modifications is advantageous for achieving high signal-to noise ratio improvement (SNRI) values and low signal distortion.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an aspect of the present disclosure, a method is provided for generating clean speech from a mixture of noise and speech. The method may include deriving, based on the mixture of noise and speech, and a model of speech, synthetic speech parameters, and synthesizing, based at least partially on the speech parameters, clean speech.

In some embodiments, deriving speech parameters commences with performing one or more spectral analyses on the mixture of noise and speech to generate one or more spectral representations. The one or more spectral representations can be then used for deriving feature data. The features corresponding to the target speech may then be grouped according to the model of speech and separated from the feature data. Analysis of feature representations may allow segmentation and grouping of speech component candidates. In certain embodiments, candidates for the features corresponding to target speech are evaluated by a multi-hypothesis tracking system aided by the model of speech. The synthetic speech parameters can be generated based partially on features corresponding to the target speech.

In some embodiments, the generated synthetic speech parameters include spectral envelope and voicing information. The voicing information may include pitch data and voice classification data. In some embodiments, the spectral envelope is estimated from a sparse spectral envelope.

In various embodiments, the method includes determining, based on a noise model, non-speech components in the feature data. The non-speech components as determined may be used in part to discriminate between speech components and noise components.

In various embodiments, the speech components may be used to determine pitch data. In some embodiments, the non-speech components may also be used in the pitch determination. (For instance, knowledge about where noise components occlude speech components may be used.) The pitch data may be interpolated to fill missing frames before synthesizing clean speech; where a missing frame refers to a frame where a good pitch estimate could not be determined.

In some embodiments, the method includes generating, based on the pitch data, a harmonic map representing voiced speech. The method may further include estimating a map for unvoiced speech based on the non-speech components from feature data and the harmonic map. The harmonic map and map for unvoiced speech may be used to generate a mask for extracting the sparse spectral envelope from the spectral representation of the mixture of noise and speech.

In further example embodiments of the present disclosure, the method steps are stored on a machine-readable medium comprising instructions, which, when implemented by one or more processors, perform the recited steps. In yet further example embodiments, hardware systems, or devices can be adapted to perform the recited steps. Other features, examples, and embodiments are described below.

### BRIEF DESCRIPTION OF THE DRAWINGS

Embodiments are illustrated by way of example and not limitation in the figures of the accompanying drawings, in which like references indicate similar elements and in which:

FIG. 1 shows an example system suitable for implementing various embodiments of the methods for generating clean speech from a mixture of noise and speech.

FIG. 2 illustrates a system for speech processing, according to an example embodiment.

FIG. 3 illustrates a system for separation and synthesis of a speech signal, according to an example embodiment.

FIG. 4 shows an example of a voiced frame.

FIG. 5 is a time-frequency plot of sparse envelope estimation for voiced frames, according to an example embodiment.

FIG. 6 shows an example of envelope estimation.

FIG. 7 is a diagram illustrating a speech synthesizer, according to an example embodiment.

FIG. 8A shows example synthesis parameters for a clean female speech sample.

FIG. 8B is a close-up of FIG. 8A showing example synthesis parameters for a clean female speech sample.

FIG. 9 illustrates an input and an output of a system for separation and synthesis of speech signals, according to an example embodiment.

FIG. 10 illustrates an example method for generating clean speech from a mixture of noise and speech.

FIG. 11 illustrates an example computer system that may be used to implement embodiments of the present technology.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

Provided are systems and methods that allow generating a clean speech from a mixture of noise and speech. Embodiments described herein can be practiced on any device that is configured to receive and/or provide a speech signal including but not limited to, personal computers (PCs), tablet computers, mobile devices, cellular phones, phone handsets, headsets, media devices, internet-connected (internet-of-things) devices and systems for teleconferencing applications. The technologies of the current disclosure may be also used in personal hearing devices, non-medical hearing aids, hearing aids, and cochlear implants.

According to various embodiments, the method for generating a clean speech signal from a mixture of noise and speech includes estimating speech parameters from a noisy mixture using auditory (e.g., perceptual) and speech production principles (e.g., separation of source and filter components). The estimated parameters are then used for synthesizing clean speech or can potentially be used in other applications where the speech signal may not necessarily be synthesized but where certain parameters or features corresponding to the clean speech signal are needed (e.g., automatic speech recognition and speaker identification).

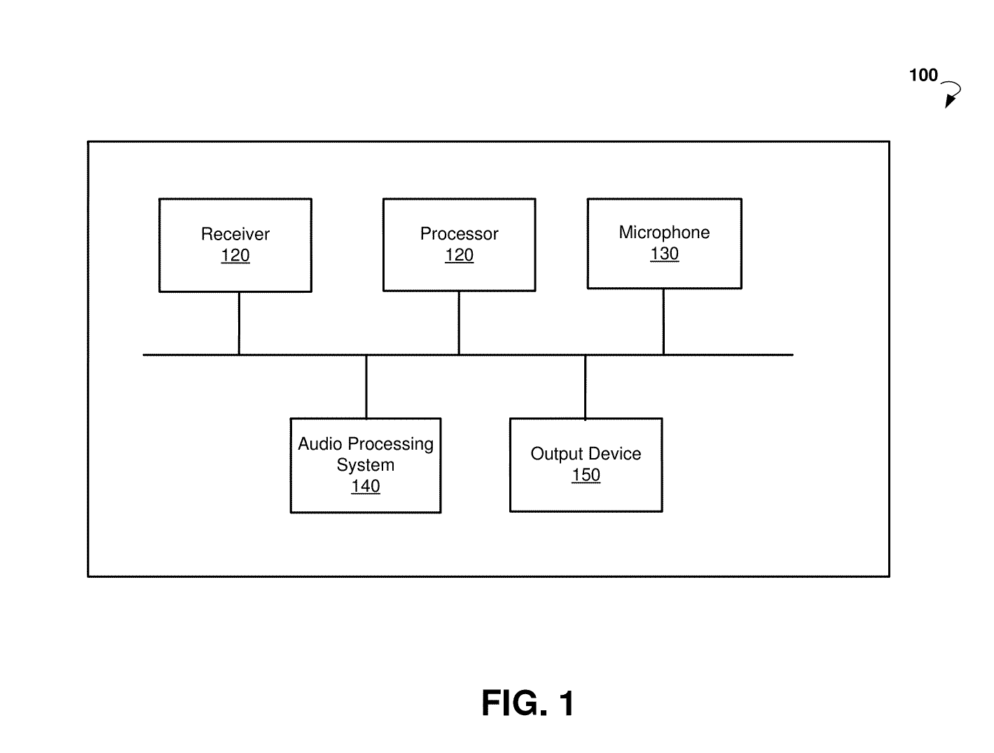

FIG. 1 shows an example system 100 suitable for implementing methods for the various embodiments described herein. In some embodiments, the system 100 comprises a receiver 110, a processor 120, a microphone 130, an audio processing system 140, and an output device 150. The system 100 may comprise more or other components to provide a particular operation or functionality. Similarly, the system 100 may comprise fewer components that perform similar or equivalent functions to those depicted in FIG. 1. In addition, elements of system 100 may be cloud-based, including but not limited to, the processor 120.

The receiver 110 can be configured to communicate with a network such as the Internet, Wide Area Network (WAN), Local Area Network (LAN), cellular network, and so forth, to receive an audio data stream, which may comprise one or more channels of audio data. The received audio data stream may then be forwarded to the audio processing system 140 and the output device 150.

The processor 120 may include hardware and software that implement the processing of audio data and various other operations depending on a type of the system 100 (e.g., communication device or computer). A memory (e.g., non-transitory computer readable storage medium) may store, at least in part, instructions and data for execution by processor 120.

The audio processing system 140 includes hardware and software that implement the methods according to various embodiments disclosed herein. The audio processing system 140 is further configured to receive acoustic signals from an acoustic source via microphone 130 (which may be one or more microphones or acoustic sensors) and process the acoustic signals. After reception by the microphone 130, the acoustic signals may be converted into electric signals by an analog-to-digital converter.

The output device 150 includes any device that provides an audio output to a listener (e.g., the acoustic source). For example, the output device 150 may comprise a speaker, a class-D output, an earpiece of a headset, or a handset on the system 100.

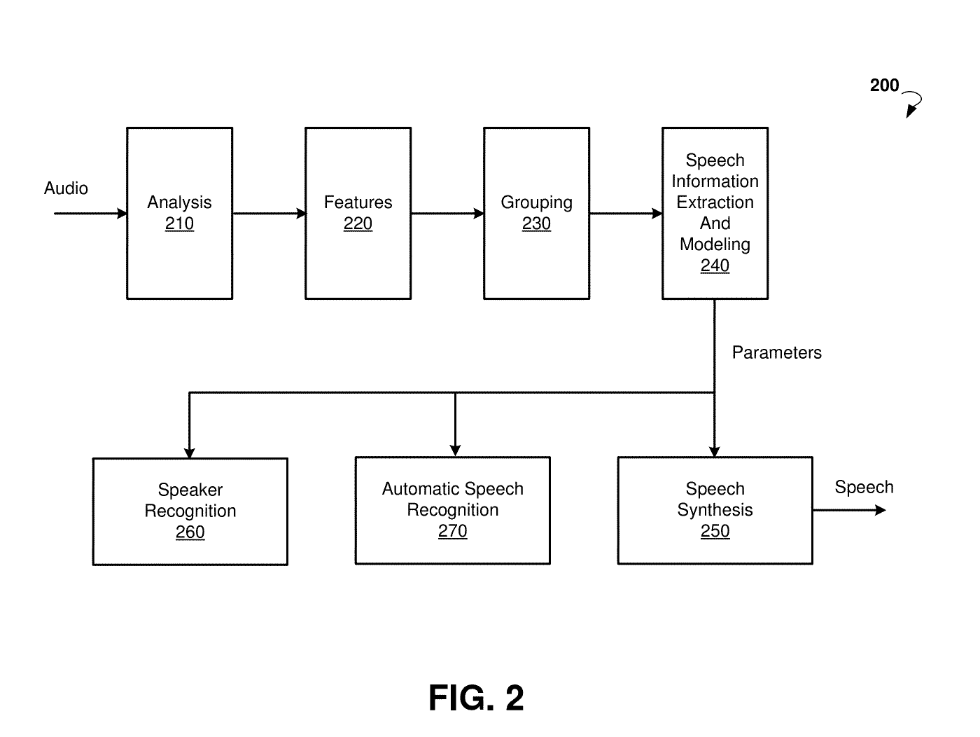

FIG. 2 shows a system 200 for speech processing, according to an example embodiment. The example system 200 includes at least an analysis module 210, a feature estimation module 220, a grouping module 230, and a speech information extraction and modeling module 240. In certain embodiments, the system 200 includes a speech synthesis module 250. In other embodiments, the system 200 includes a speaker recognition module 260. In yet further embodiments, the system 200 includes an automatic speech recognition module 270.

In some embodiments, the analysis module 210 is operable to receive one or more time-domain speech input signals. The speech input can be analyzed with a multi-resolution front end that yields spectral representations at various predetermined time-frequency resolutions.

In some embodiments, the feature estimation module 220 receives various analysis data from the analysis module 210. Signal features can be derived from the various analyses according to the type of feature (for example, a narrowband spectral analysis for tone detection and a wideband spectral analysis for transient detection) to generate a multi-dimensional feature space.

In various embodiments, the grouping module 230 receives the feature data from the feature estimation module 220. The features corresponding to target speech may then be grouped according to auditory scene analysis principles (e.g., common fate) and separated from the features of the interference or noise. In certain embodiments, in the case of multi-talker input or other speech-like distractors, a multi-hypothesis grouper can be used for scene organization.

In some embodiments, the order of the grouping module 230 and feature estimation module 220 may be reversed, such that grouping module 230 groups the spectral representation (e.g., from analysis module 210) before the feature data is derived in feature estimation module 220.

A resultant sparse multi-dimensional feature set may be passed from the grouping module 230 to the speech information extraction and modeling module 240. The speech information extraction and modeling module 240 can be operable to generate output parameters representing the target speech in the noisy speech input.

In some embodiments, the output of the speech information extraction and modeling module 240 includes synthesis parameters and acoustic features. In certain embodiments, the synthesis parameters are passed to the speech synthesis module 250 for synthesizing clean speech output. In other embodiments, the acoustic features generated by speech information extraction and modeling module 240 are passed to the automatic speech recognition module 270 or the speaker recognition module 260.

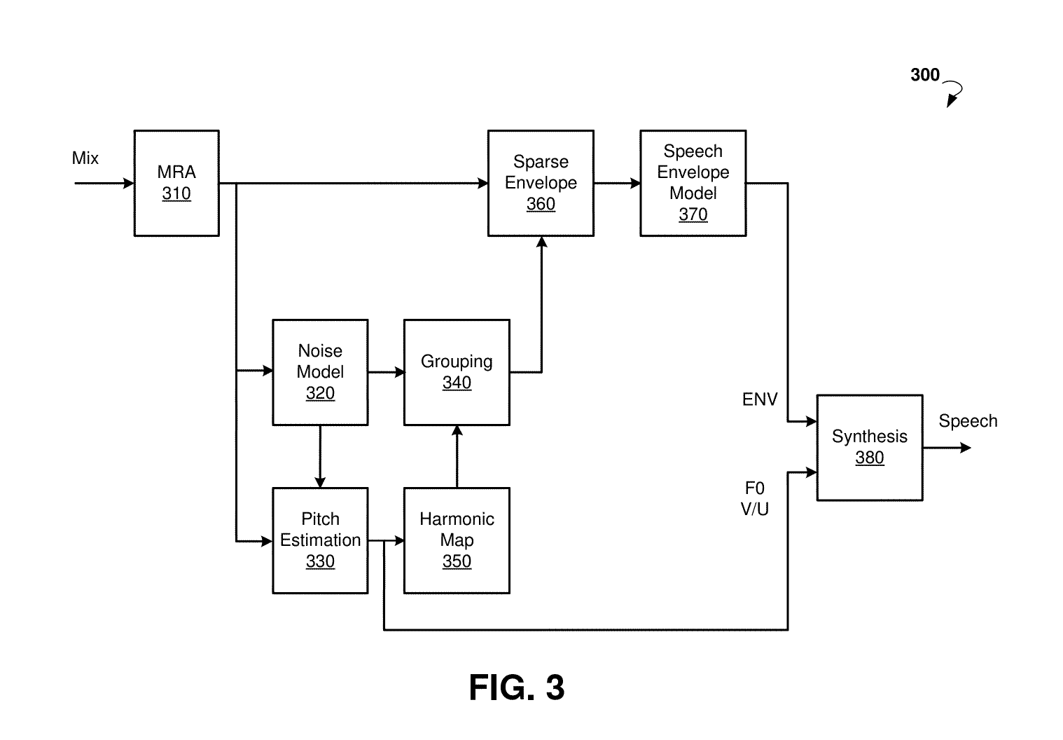

FIG. 3 shows a system 300 for speech processing, specifically, speech separation and synthesis for noise suppression, according to another example embodiment. The system 300 may include a multi-resolution analysis (MRA) module 310, a noise model module 320, a pitch estimation module 330, a grouping module 340, a harmonic map unit 350, a sparse envelope unit 360, a speech envelope model module 370, and a synthesis module 380.

In some embodiments, the MRA module 310 receives the speech input signal. The speech input signal can be contaminated by additive noise and room reverberation. The MRA module 310 can be operable to generate one or more short-time spectral representations.

This short-time analysis from the MRA module 310 can be initially used for deriving an estimate of the background noise via the noise model module 320. The noise estimate can then be used for grouping in grouping module 340 and to improve the robustness of pitch estimation in pitch estimation module 330. The pitch track generated by the pitch estimation module 330, including a voicing decision, may be used for generating a harmonic map (at the harmonic map unit 350) and as an input to the synthesis module 380.

In some embodiments, the harmonic map (which represents the voiced speech), from the harmonic map unit 350, and the noise model, from the noise model module 320, are used for estimating a map of unvoiced speech (i.e., the difference between the input and the noise model in a non-voiced frame). The voiced and unvoiced maps may then be grouped (at the grouping module 340) and used to generate a mask for extracting a sparse envelope (at the sparse envelope unit 360) from the input signal representation. Finally, the speech envelope model module 370 may estimate the spectral envelope (ENV) from the sparse envelope and may feed the ENV to the speech synthesizer (e.g., synthesis module 380), which together with the voicing information (pitch F0 and voicing classification such as voiced/unvoiced (V/U)) from the pitch estimation module 330) can generate the final speech output.

In some embodiments, the system of FIG. 3 is based on both human auditory perception and speech production principles. In certain embodiments, the analysis and processing are performed for envelope and excitation separately (but not necessarily independently). According to various embodiments, speech parameters (i.e., envelope and voicing in this instance) are extracted from the noisy observation and the estimates are used to generate clean speech via the synthesizer.

### Noise Modeling

The noise model module 320 may identify and extract non-speech components from the audio input. This may be achieved by generating a multi-dimensional representation, such as a cortical representation, for example, where discrimination between speech and non-speech is possible. Some background on cortical representations is provided in M. Elhilali and S. A. Shamma, “A cocktail party with a cortical twist: How cortical mechanisms contribute to sound segregation,” J. Acoust. Soc. Am. 124(6): 3751-3771 (December 2008), the disclosure of which is incorporated herein by reference in its entirety.

In the example system 300, the multi-resolution analysis may be used for estimating the noise by noise model module 320. Voicing information such as pitch may be used in the estimation to discriminate between speech and noise components. For broadband stationary noise, a modulation-domain filter may be implemented for estimating and extracting the slowly-varying (low modulation) components characteristic of the noise but not of the target speech. In some embodiments, alternate noise modeling approaches such as minimum statistics may be used.

### Pitch Analysis and Tracking

The pitch estimation module 330 can be implemented based on autocorrelogram features. Some background on autocorrelogram features is provided in Z. Jin and D. Wang, “HMM-Based Multipitch Tracking for Noisy and Reverberant Speech,” IEEE Transactions on Audio, Speech, and Language Processing, 19(5):1091-1102 (July 2011), the disclosure of which is incorporated herein by reference in its entirety. Multi-resolution analysis may be used to extract pitch information from both resolved harmonics (narrowband analysis) and unresolved harmonics (wideband analysis). The noise estimate can be incorporated to refine pitch cues by discarding unreliable sub-bands where the signal is dominated by noise. In some embodiments, a Bayesian filter or Bayesian tracker (for example, a hidden Markov model (HMM)) is then used to integrate per-frame pitch cues with temporal constraints in order to generate a continuous pitch track. The resulting pitch track may then be used for estimating a harmonic map that highlights time-frequency regions where harmonic energy is present. In some embodiments, suitable alternate pitch estimation and tracking methods, other than methods based on autocorrelogram features, are used.

For synthesis, the pitch track may be interpolated for missing frames and smoothed to create a more natural speech contour. In some embodiments, a statistical pitch contour model is used for interpolation/extrapolation and smoothing. Voicing information may be derived from the saliency and confidence of the pitch estimates.

### Sparse Envelope Extraction

Once the voiced speech and background noise regions are identified, an estimate of the unvoiced speech regions may be derived. In some embodiments, the feature region is declared unvoiced if the frame is not voiced (that determination may be based, e.g., on a pitch saliency, which is a measure of how pitched the frame is) and the signal does not conform to the noise model, e.g., the signal level (or energy) exceeds a noise threshold or the signal representation in the feature space falls outside the noise model region in the feature space.

The voicing information may be used to identify and select the harmonic spectral peaks corresponding to the pitch estimate. The spectral peaks found in this process may be stored for creating the sparse envelope.

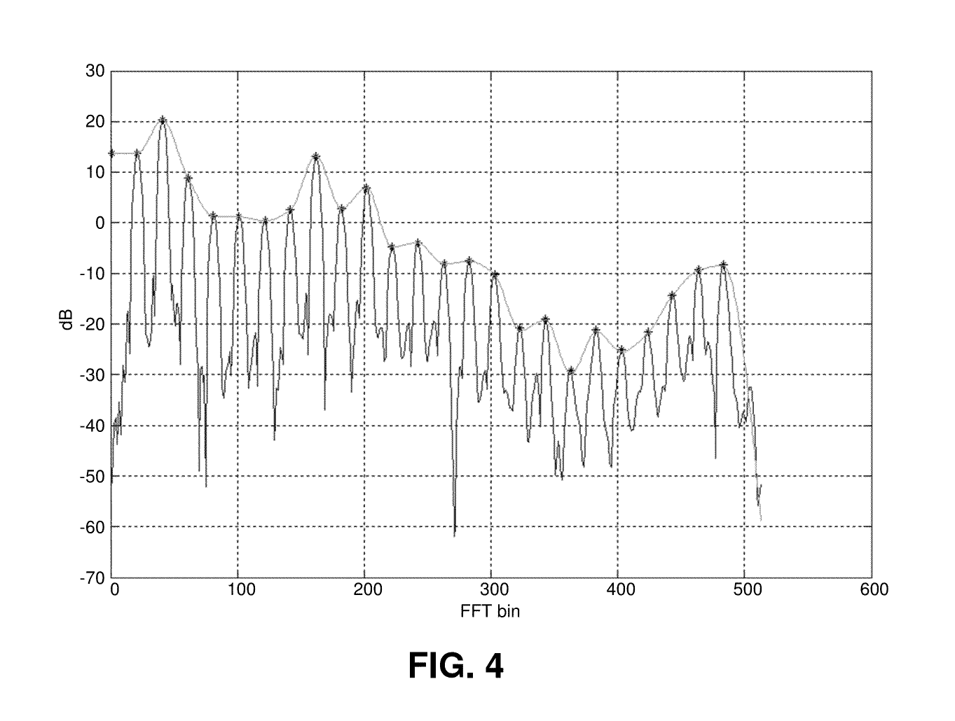

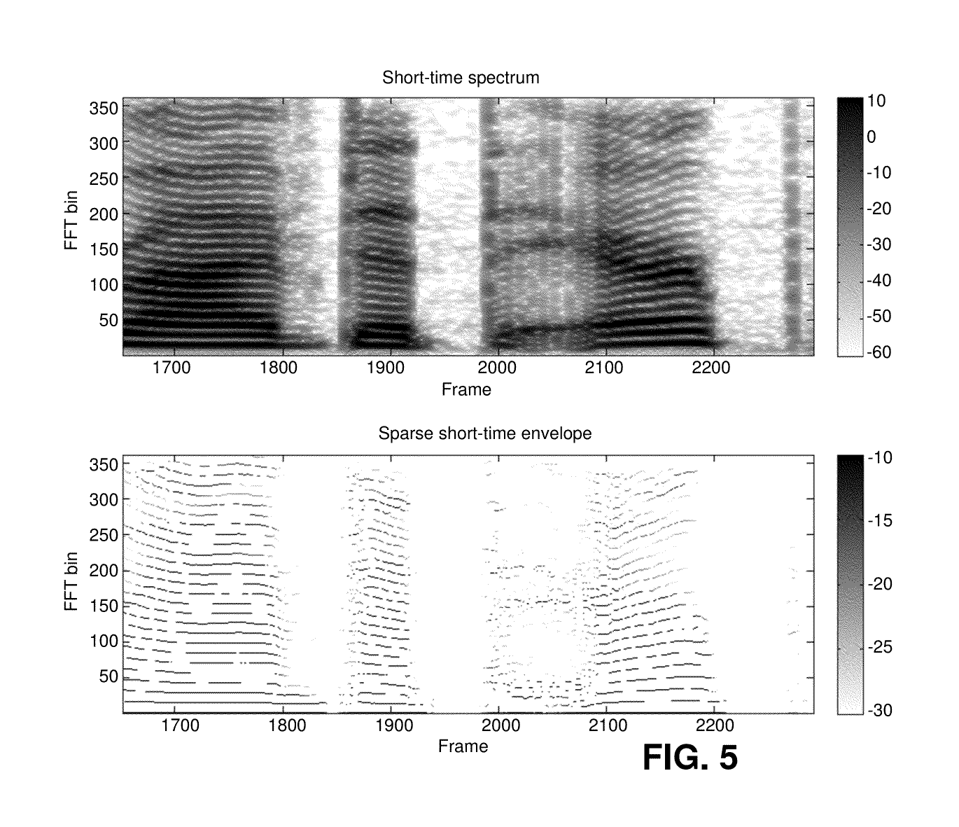

For unvoiced frames, all spectral peaks may be identified and added to the sparse envelope signal. An example for a voiced frame is shown in FIG. 4. FIG. 5 is an exemplary time-frequency plot of the sparse envelope estimation for a voiced frame.

### Spectral Envelope Modeling

The spectral envelope may be derived from the sparse envelope by interpolation. Many methods can be applied to derive the sparse envelope, including simple two-dimensional mesh interpolation (e.g., image processing techniques) or more sophisticated data-driven methods which may yield more natural and undistorted speech.

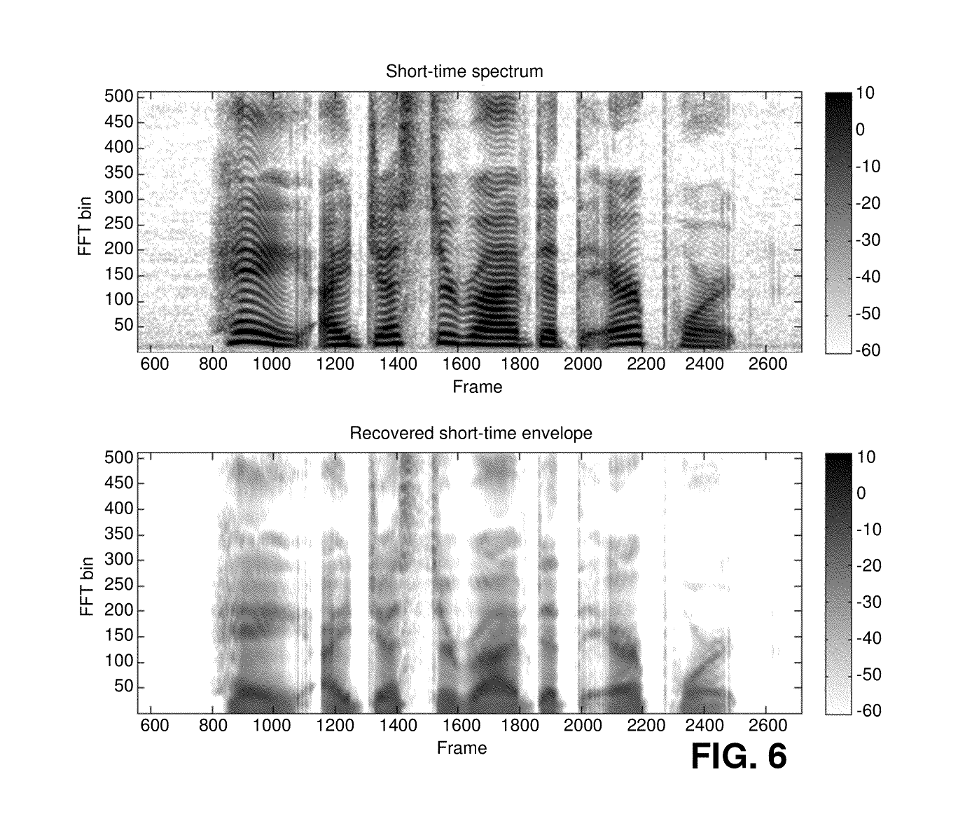

In the example shown in FIG. 6, cubic interpolation in the logarithmic domain is applied on a per-frame basis to the sparse spectrum to obtain a smooth spectral envelope. Using this approach, the fine structure due to the excitation may be removed or minimized. Where noise exceeds the speech harmonics, the envelope may be assigned a weighted value based on some suppression law (e.g., Wiener filter) or based on a speech envelope model.

### Speech Synthesis

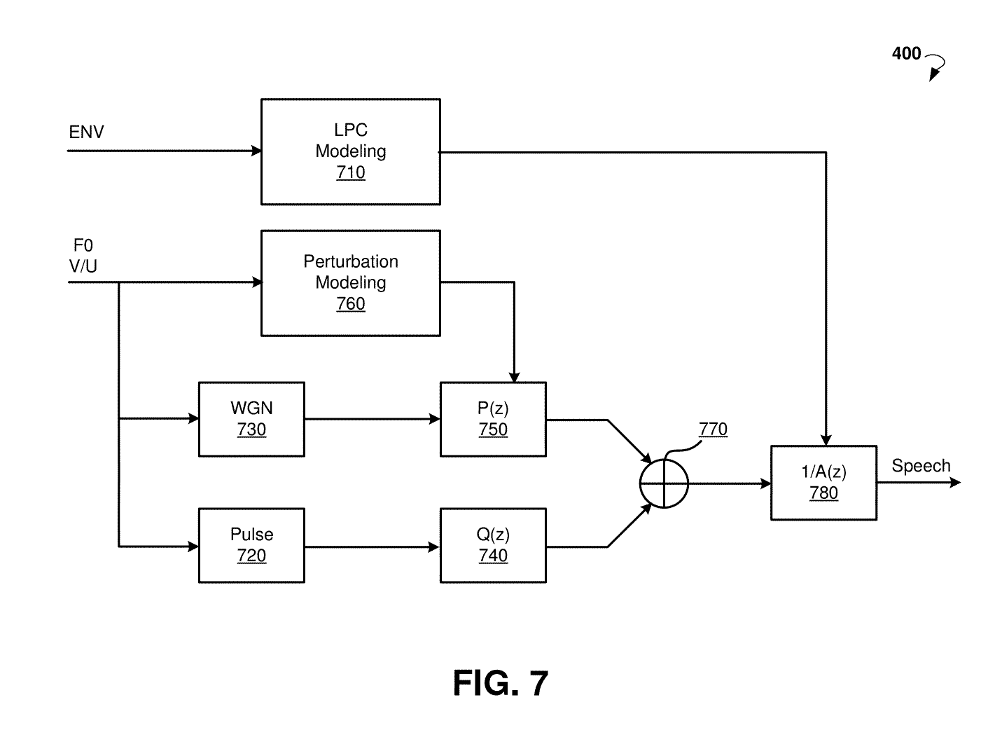

FIG. 7 is block diagram of a speech synthesizer 700, according to an example embodiment. The example speech synthesizer 700 can include a Linear Predictive Coding (LPC) Modeling block 710, a Pulse block 720, a White Gaussian Noise (WGN) block 730, Perturbation Modeling block 760, Perturbation filters 740 and 750, and a Synthesis filter 780.

Once the pitch track and the spectral envelope are computed, a clean speech utterance may be synthesized. With these parameters, a mixed-excitation synthesizer may be implemented as follows. The spectral envelope (ENV) may be modeled by a high-order Linear Predictive Coding (LPC) filter (e.g., 64th order) to preserve vocal tract detail but exclude other excitation-related artifacts (LPC Modeling block 710, FIG. 7). The excitation (of voicing information (pitch F0 and voicing classification such as voiced/unvoiced (V/U) in the example in FIG. 7)) may be modeled by the sum of a filtered pulse train (Pulse block 720, FIG. 7) driven by the pitch value in each frame and a filtered White Gaussian Noise source (WGN block 730, FIG. 7). As can be seen in the example embodiment in FIG. 7, the pitch F0 and voicing classification such as voiced/unvoiced (V/U) may be input to Pulse block 720, WGN block 730, and Perturbation Modeling block 760. Perturbation filters P(z) 750 and Q(z) 740 may be derived from the spectro-temporal energy profile of the envelope.

In contrast to other known methods, the perturbation of the periodic pulse train can be controlled only based on the relative local and global energy of the spectral envelope and not based on an excitation analysis, according to various embodiments. The filter P(z) 750 may add spectral shaping to the noise component in the excitation, and the filter Q(z) 740 may be used to modify the phase of the pulse train to increase dispersion and naturalness.

To derive the perturbation filters P(z) 750 and Q(z) 740, the dynamic range within each frame may be computed, and a frequency-dependent weight may be applied based on the level of each spectral value relative to the minimum and maximum energy in the frame. Then, a global weight may be applied based on the level of the frame relative to the maximum and minimum global energies tracked over time. The rationale behind this approach is that during onsets and offsets (low relative global energy) the glottis area is reduced, giving rise to higher Reynolds numbers (increased probability of turbulence). During the steady state, local frequency perturbations can be observed at lower energies where turbulent energy dominates.

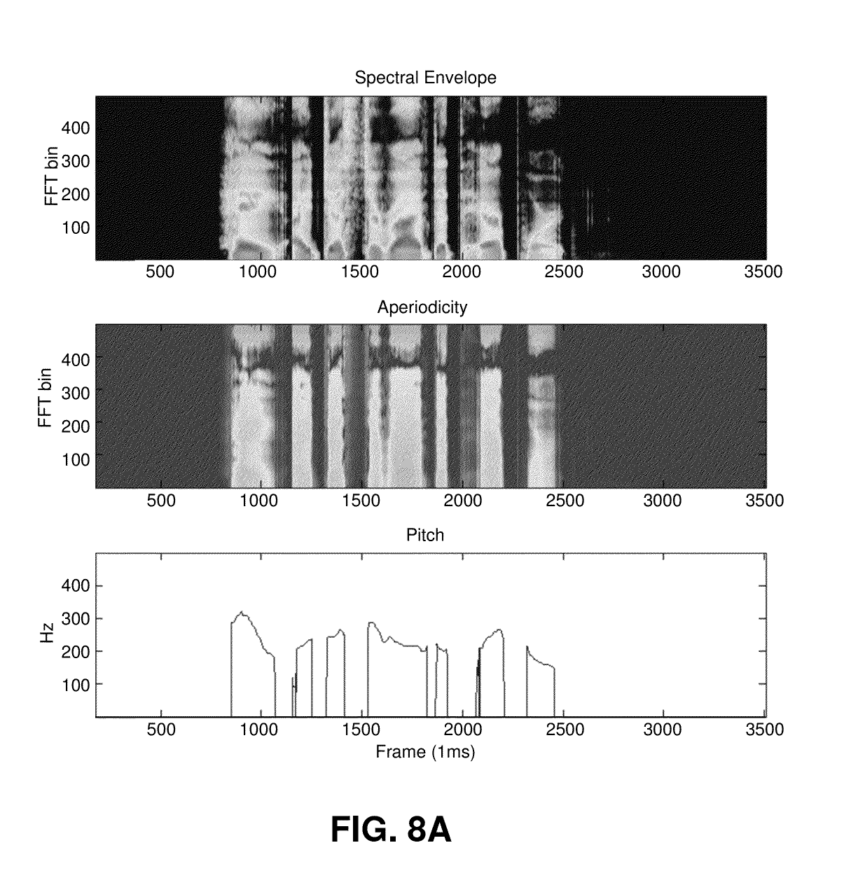

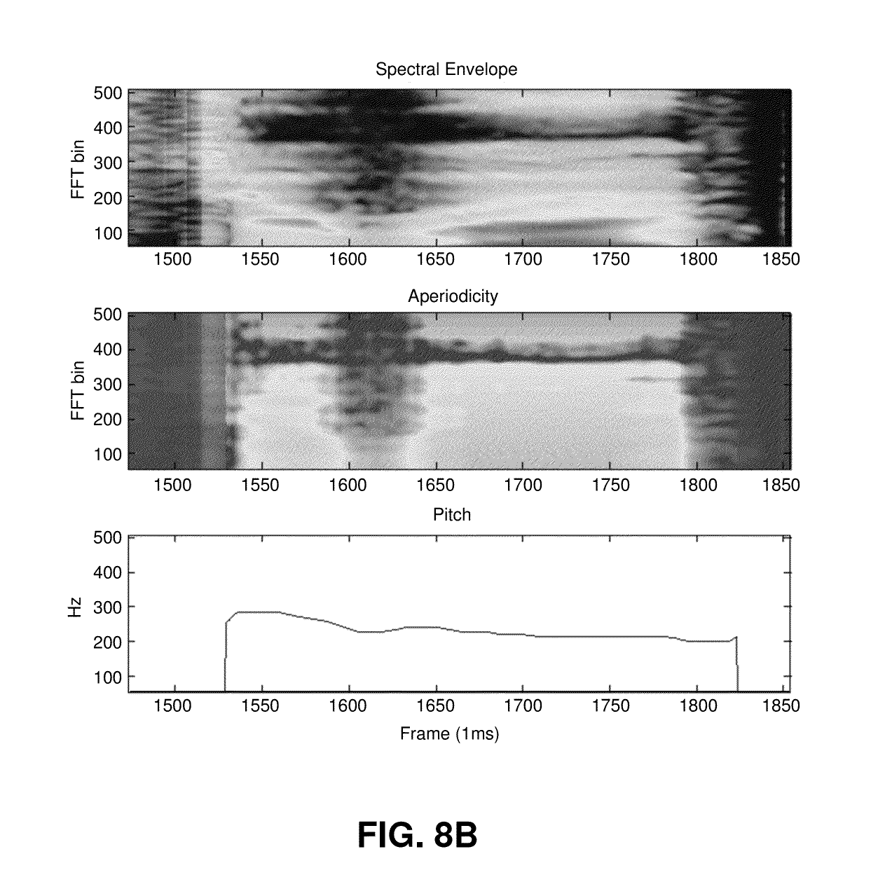

It should be noted that the perturbation may be computed from the spectral envelope in voiced frames, but, in practice, for some embodiments, the perturbation is assigned a maximum value during unvoiced regions. An example of the synthesis parameters for a clean female speech sample is shown in FIG. 8A (also shown in more detail in FIG. 8B). The perturbation function is shown in the dB domain as an aperiodicity function.

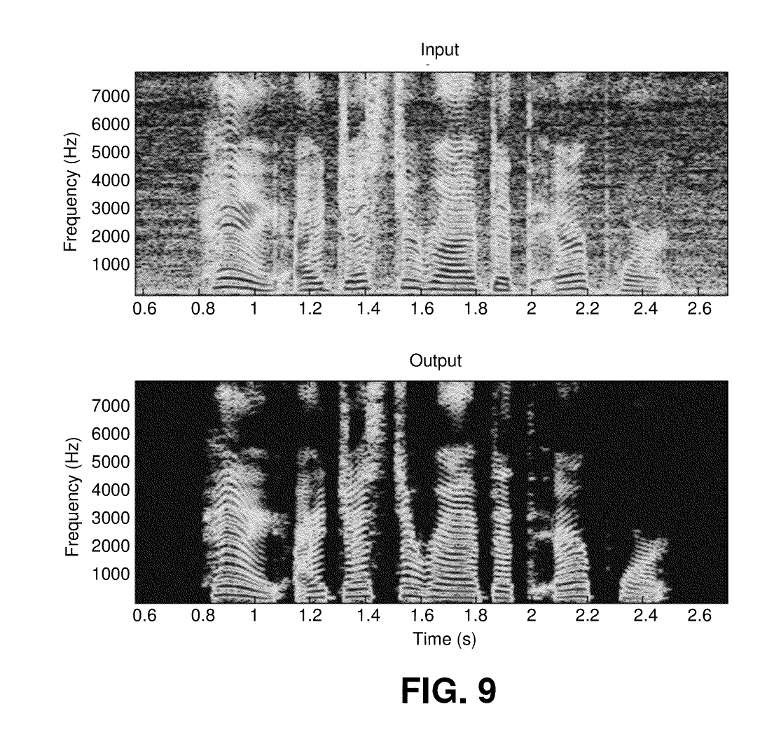

An example of the performance of the system 300 is illustrated in FIG. 9, where a noisy speech input is processed by the system 300, thereby producing a synthetic noise-free output.

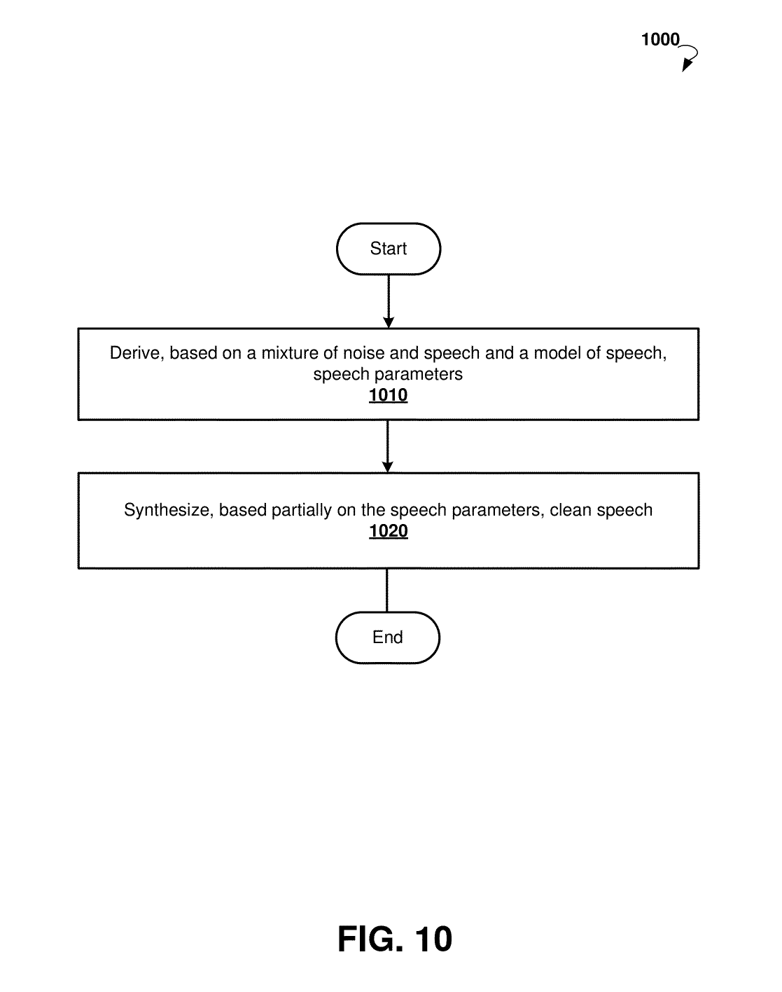

FIG. 10 is a flow chart of method 1000 for generating clean speech from a mixture of noise and speech. The method 1000 may be performed by processing logic that may include hardware (e.g., dedicated logic, programmable logic, and microcode), software (such as run on a general-purpose computer system or a dedicated machine), or a combination of both. In one example embodiment, the processing logic resides at the audio processing system 140.

At operation 1010, the example method 1000 can include deriving, based on the mixture of noise and speech and a model of speech, speech parameters. The speech parameters may include the spectral envelope and voice information. The voice information may include pitch data and voice classification. At operation 1020, the method 1000 can proceed with synthesizing clean speech from the speech parameters.

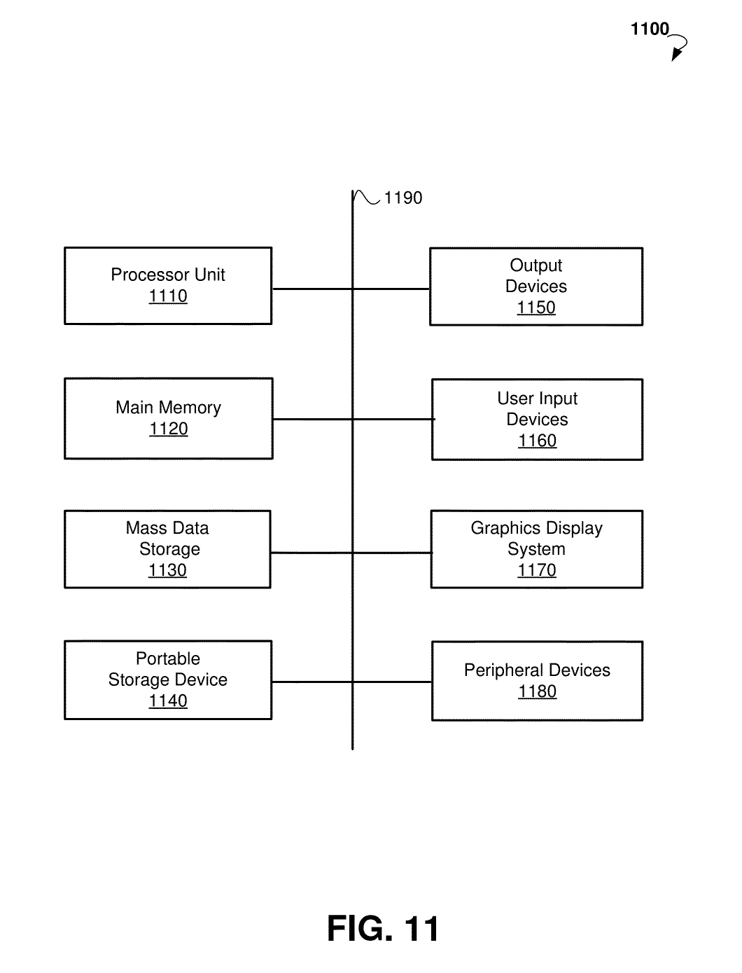

FIG. 11 illustrates an exemplary computer system 1100 that may be used to implement some embodiments of the present invention. The computer system 1100 of FIG. 11 may be implemented in the contexts of the likes of computing systems, networks, servers, or combinations thereof. The computer system 1100 of FIG. 11 includes one or more processor units 1110 and main memory 1120. Main memory 1120 stores, in part, instructions and data for execution by processor units 1110. Main memory 1120 stores the executable code when in operation, in this example. The computer system 1100 of FIG. 11 further includes a mass data storage 1130, portable storage device 1140, output devices 1150, user input devices 1160, a graphics display system 1170, and peripheral devices 1180.

The components shown in FIG. 11 are depicted as being connected via a single bus 1190. The components may be connected through one or more data transport means. Processor unit 1110 and main memory 1120 are connected via a local microprocessor bus, and the mass data storage 1130, peripheral device(s) 1180, portable storage device 1140, and graphics display system 1170 are connected via one or more input/output (I/O) buses.

Mass data storage 1130, which can be implemented with a magnetic disk drive, solid state drive, or an optical disk drive, is a non-volatile storage device for storing data and instructions for use by processor unit 1110. Mass data storage 1130 stores the system software for implementing embodiments of the present disclosure for purposes of loading that software into main memory 1120.

Portable storage device 1140 operates in conjunction with a portable non-volatile storage medium, such as a flash drive, floppy disk, compact disk, digital video disc, or Universal Serial Bus (USB) storage device, to input and output data and code to and from the computer system 1100 of FIG. 11. The system software for implementing embodiments of the present disclosure is stored on such a portable medium and input to the computer system 1100 via the portable storage device 1140.

User input devices 1160 can provide a portion of a user interface. User input devices 1160 may include one or more microphones, an alphanumeric keypad, such as a keyboard, for inputting alphanumeric and other information, or a pointing device, such as a mouse, a trackball, stylus, or cursor direction keys. User input devices 1160 can also include a touchscreen. Additionally, the computer system 1100 as shown in FIG. 11 includes output devices 1150. Suitable output devices 1150 include speakers, printers, network interfaces, and monitors.

Graphics display system 1170 include a liquid crystal display (LCD) or other suitable display device. Graphics display system 1170 is configurable to receive textual and graphical information and processes the information for output to the display device.

Peripheral devices 1180 may include any type of computer support device to add additional functionality to the computer system.

The components provided in the computer system 1100 of FIG. 11 are those typically found in computer systems that may be suitable for use with embodiments of the present disclosure and are intended to represent a broad category of such computer components that are well known in the art. Thus, the computer system 1100 of FIG. 11 can be a personal computer (PC), hand held computer system, telephone, mobile computer system, workstation, tablet, phablet, mobile phone, server, minicomputer, mainframe computer, wearable, internet-connected device, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 1100 is implemented as a cloud-based computing environment, such as a virtual machine operating within a computing cloud. In other embodiments, the computer system 1100 may itself include a cloud-based computing environment, where the functionalities of the computer system 1100 are executed in a distributed fashion. Thus, the computer system 1100, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computer system 1100, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

1. A method for generating clean speech from a mixture of noise and speech, the method comprising:
deriving, based on the mixture of noise and speech and a model of speech, speech parameters, the deriving using at least one hardware processor; and
synthesizing, based at least partially on the speech parameters, clean speech.

2. The method of claim 1, wherein deriving speech parameters comprises:
performing one or more spectral analyses on the mixture of noise and speech to generate one or more spectral representations;
deriving, based on the one or more spectral representations, feature data;
grouping target speech features in the feature data according to the model of speech;
separating the target speech features from the feature data; and
generating, based at least partially on target speech features, the speech parameters.

3. The method of claim 2, wherein candidates for target speech features are evaluated by a multi-hypothesis tracking system aided by the model of speech.

4. The method of claim 2, wherein the speech parameters include spectral envelope and voicing information, the voicing information including pitch data and voice classification data.

5. The method of claim 4, further comprising, prior to grouping the feature data, determining, based on a noise model, non-speech components in the feature data.

6. The method of claim 5, wherein the pitch data are determined based, at least partially, on the non-speech components.

7. The method of claim 5, wherein the pitch data are determined based, at least on, knowledge about where noise components occlude speech components.

8. The method of claim 6, further comprising, while generating the speech parameters:
generating, based on the pitch data, a harmonic map, the harmonic map representing voiced speech; and
estimating, based on the non-speech components and the harmonic map, an unvoiced speech map.

9. The method of claim 8, further comprising extracting a sparse spectral envelope from the one or more spectral representations using a mask, the mask being generated based on a harmonic map and an unvoiced speech map.

10. The method of claim 9, further comprising estimating the spectral envelope based on a sparse spectral envelope.

11. The method of claim 4, wherein the pitch data are interpolated to fill missing frames before synthesizing clean speech.

12. The method of claim 1, wherein deriving speech parameters comprises:
performing one or more spectral analyses on the mixture of noise and speech to generate one or more spectral representations;
grouping the one or more spectral representations;
deriving, based on one of more of the grouped spectral representations, feature data;
separating the target speech features from the feature data; and
generating, based at least partially on target speech features, the speech parameters.

13. A system for generating clean speech from a mixture of noise and speech, the system comprising:
one or more processors; and
a memory communicatively coupled with the processor, the memory storing instructions which when executed by the one or more processors perform a method comprising:
deriving, based on the mixture of noise and speech and a model of speech, speech parameters; and
synthesizing, based at least partially on the speech parameters, clean speech.

14. The system of claim 13, wherein deriving speech parameters comprises:
performing one or more spectral analyses on the mixture of noise and speech to generate one or more spectral representations;
deriving, based on the one or more spectral representations, feature data;
grouping target speech features in the feature data according to the model of speech;
separating the target speech features from the feature data; and
generating, based, at least partially on target speech features, the speech parameters.

15. The system of claim 14, wherein candidates for target speech features are evaluated by a multi-hypothesis tracking system aided by the model of speech.

16. The system of claim 14, wherein the speech parameters include a spectral envelope and voicing information, the voicing information including pitch data and voice classification data.

17. The system of claim 16, further comprising, prior to grouping the feature data, determining, based on a noise model, non-speech components in the feature data.

18. The system of claim 17, wherein the pitch data are determined based partially on the non-speech components.

19. The system of claim 17, wherein the pitch data are determined based, at least on, knowledge about where noise components occlude speech components.

20. The system of claim 18, further comprising, while generating the speech parameters:
generating, based on the pitch data, a harmonic map, the harmonic map representing voiced speech; and
estimating, based on the non-speech components and the harmonic map, an unvoiced speech map.

21. The system of claim 18, further comprising extracting a sparse spectral envelope from the one or more spectral representations using a mask, the mask being generated based on a harmonic map and an unvoiced speech map.

22. The system of claim 21, further comprising estimating the spectral envelope based on the sparse spectral envelope.

23. The system of claim 13, wherein deriving speech parameters comprises:
performing one or more spectral analyses on the mixture of noise and speech to generate one or more spectral representations;
grouping the one or more spectral representations;
deriving, based on one of more of the grouped spectral representations, feature data;
separating the target speech features from the feature data; and
generating, based at least partially on target speech features, the speech parameters.

24. A non-transitory computer-readable storage medium having embodied thereon a program, the program being executable by a processor to perform a method for generating clean speech from a mixture of noise and speech, the method comprising:
deriving, based on the mixture of noise and speech and a model of speech, via instructions stored in the memory and executed by the one or more processors, speech parameters; and
synthesizing, based at least partially on the speech parameters, via instructions stored in the memory and executed by the one or more processors, clean speech.
